(19) United States
(12) Patent Application Publication
(10) Pub. No.: US 2010/0083231 A1
(43) Pub. Date: Apr. 1, 2010

(54) System And Method For Safe Code Loading

(75) Inventor: Sean O. Snider, La Jolla, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/241,627

(22) Filed: Sep. 30, 2008

(51) Int. Cl. G06F 17/30

(52) U.S. Cl. 717/124; 707/E17.032; 707/705

(57) ABSTRACT

Described embodiments disclose methods, apparatuses, and systems directed to loading code objects from different origins into structured documents operating within the context of a client application. In a particular implementation, a manager code object within a structured document receives a request for additional code. The manager code object may then initiate the creation of a first frame within the structured document, passing to the first frame parameters regarding the request for the additional code. The first frame may analyze the parameters for errors and report errors if any is found. If no errors are found, the first frame may retrieve the additional code. The first frame may initiate the creation of a second frame within the structured document and pass parameters regarding the retrieval of the additional code to the second frame. The second frame may utilize these parameters to report errors to the manager code regarding the retrieval of the additional code. The second frame may utilize these parameters to instruct the manager code how to retrieve the additional code.

### TECHNICAL FIELD

The present disclosure generally relates to communication between code objects executable within the context of a web page or other structured document processed by a browser or other client application.

### BACKGROUND

When utilizing the Internet, clients may visit Web sites which provide a large amount of functionality through code embedded into the Web page. In order to optimize the speed of the site as perceived by the user, resources (such as code to be downloaded) may be stored on edge servers rather than the server which hosts the Web page the client visits. Edge servers may be geographically positioned closer to the client's location thereby providing faster downloading of the code. Clients may have restrictions, though, regarding downloading code from servers at different domains. For example, when working with Javascript code, clients may have a cross-domain restriction wherein code may not be retrieved from another server than the server which provided the Web page. However, clients may have exceptions to such restrictions. For example, a client may be configured to allow code to be downloaded from another domain (server) if an HTML “script” tag is used to download the code. By utilizing such tags, code which is to be downloaded later may be retrieved from edge servers which may prove quicker than downloading the code from the original server.

However, using such mechanisms to retrieve code from edge servers may be problematic. For example, if there is a communication error during the attempted retrieval, the client may not be able to provide any response because the “script” tags do not provide error-reporting. Thus, the user of the client may not appreciate that an error has occurred and may believe the Web site is not operating properly. The user may refresh the entire page if the site becomes unresponsive due to errors while retrieving code, causing the client to have to setup the page once again. This may be time consuming and counter-productive.

### SUMMARY

Described embodiments disclose methods, apparatuses, and systems directed to loading code objects from different origins into structured documents operating within the context of a client application. In a particular implementation, a manager code object within a structured document receives a request for additional code. The manager code object may then initiate the creation of a first frame within the structured document, passing to the first frame parameters regarding the request for the additional code. The first frame may analyze the parameters for errors and report errors if any is found. If no errors are found, the first frame may retrieve the additional code. The first frame may initiate the creation of a second frame within the structured document and pass parameters regarding the retrieval of the additional code to the second frame. The second frame may utilize these parameters to report errors to the manager code regarding the retrieval of the additional code. The second frame may utilize these parameters to instruct the manager code how to retrieve the additional code.

### BRIEF DESCRIPTION OF THE DRAWINGS

Reference is now made to the following description taken in conjunction with the accompanying drawings, wherein like reference numbers represent like parts and which:

FIG. 1 illustrates an example network environment;

FIG. 2 is a flowchart depicting an example operation of the manager code illustrated in FIG. 1;

FIG. 3 is a flowchart depicting an example operation of the first frame illustrated in FIG. 1; and

FIG. 4 is a flowchart depicting an example operation of the second frame illustrated in FIG. 1.

### DETAILED DESCRIPTION

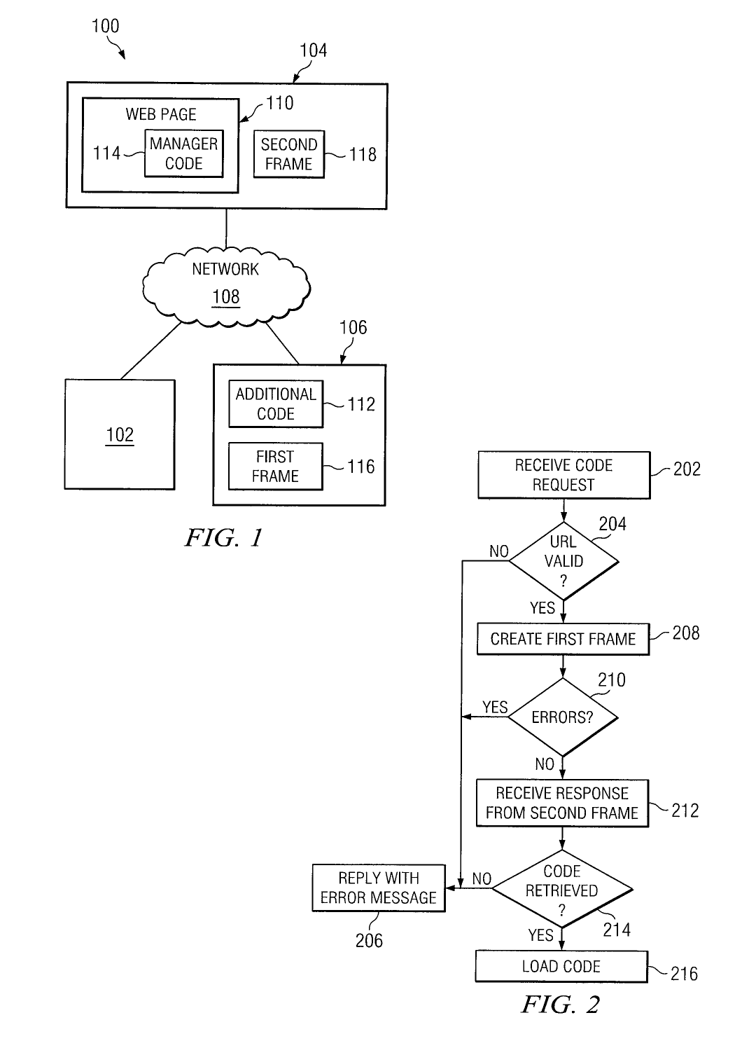

FIG. 1 illustrates an example network environment 100 in which particular implementations may operate. As FIG. 1 illustrates, example network environment 100 may comprise client 102, origin server 104, and edge server 106. Each of these may be coupled to each other through network 108. In some embodiments, origin server 104 and edge server 106 have different domains. Utilizing network 108, client 102 may be able to request and receive code (e.g., HTML and/or Javascript) from origin server 104 as well as edge server 106. Web page 110 may include manager code 114. Edge server may contain first frame 116 and origin server 104 may contain second frame 118. For example, client 102 may first request code from origin server 104 (such as Web page 110); then, manager code 114 may request and receive additional code (such as additional code 112) from edge server 106. Manager code 114 may utilize frames 116 and 118 while retrieving additional code 112.

In some embodiments, origin server 104 and edge server 106 may comprise a plurality of servers or other equipment, each performing different or the same functions in order to receive and communicate information. They may include software and/or algorithms to achieve the operations for processing, communicating, delivering, gathering, uploading, maintaining, and/or generally managing data, as described herein. Alternatively, such operations and techniques may be achieved by any suitable hardware, component, device, application specific integrated circuit (ASIC), additional software, field programmable gate array (FPGA), server, processor, algorithm, erasable programmable ROM (EPROM), electrically erasable programmable ROM (EEPROM), or any other suitable object that is operable to facilitate such operations.

In some embodiments, client 102 may include personal computers or mobile devices, such as laptop computers, personal digital assistants (PDAs), mobile phones, etc. Client 102 may include one or more processors, a memory, a network interface, one or more input/output (I/O) devices and a system bus interconnecting these components. Client 102 may also include an operating system and a user agent, such as a browser client. Browser clients may include Microsoft® Internet Explorer®), Mozilla Firefox®, Apple® Safari®, Netscape® Navigator®, and any other suitable user agent. Such browser clients may support a domain security model that disallows interaction between content (e.g., code objects and scripts) served from different origins. For example, a security model may implement a domain restriction with respect to code objects loaded into different inline frames, such that code objects from different origins, operating in the context of different inline frames, are prevented from interacting. In a particular implementation, an origin is defined as a combination of a host name, port, and protocol. A host name could be an IP address or a domain name. A port refers to a Transport Control Protocol/Internet Protocol (TCP/IP) port, while protocol refers to protocol layers above the transport layer, such as HTTP, S-HTTP, HTTP over Secure Sockets Layer (HTTPS). Still further, some browsers consider an IP address (e.g., 66.213.145.93) and a domain name that resolves to that IP address to be different origins when used in connection with inline frames.

In some embodiments, network 108 may be a communicative platform operable to exchange data or information. It could be a plain old telephone system (POTS). In other embodiments, it could be any packet data network offering a communications interface or exchange between any two nodes in network environment 100. It may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment, including a combination of any networks or systems described above. In various embodiments, network connections may include, but are not limited to, wired and/or wireless mediums which may be provisioned with routers and firewalls.

In some embodiments, frames 116 and 118 may include code which is operable to accomplish the tasks described below. The code comprised by frames 116 and 118 may include HTML, Javascript, Perl, Python, Ruby, or other suitable languages. In certain embodiments, frames 116 and 118 may include inline frames. Frames 116 and 118 may also be realized through plugins, such as Java, Flash, Silverlight, or other suitable plugin architectures. In particular embodiments, frames 116 and 118 may include substantially the same code. This may be advantageous in that the code may be cached leading to increased performance. Second frame 118 may be served from the same server as manager code 114, which may enable second frame 118 to communicate with manager code 114. First frame 116 may be served from the same server as additional code 112 which may allow first frame 116 to retrieve additional code 112 utilizing mechanisms which would not otherwise be available. This may be advantageous in several respects. For example, first frame 116 may retrieve additional code 112 with mechanisms that provide error reporting as well as the ability to test additional code 112 before executing it. Further examples are discussed below with respect to FIGS. 2-4.

In an example operation, client 102 may request and receive Web page 110 from origin server 104. Web page 110 may include manager code 114 that handles requests for additional code, such as additional code 112 stored in edge server 106. When a request for additional code 112 is made, client 102 may be directed to instantiate first frame 116 by manager code 114. The source of first frame 116 may be stored within edge server 106. First frame 116 may be configured to receive requests for additional code 112 stored at edge server 106. First frame 116 may further be configured to report errors encountered while processing the request for additional code 112. In some embodiments, at the conclusion of the processing of the request for additional code 112, first frame 116 may instruct client 102 to instantiate second frame 118 whose source may be stored in origin server 104. Second frame 118 may be configured to receive status information as to the retrieval of additional code 112, and may communicate this status information to manager code 114. In certain instances, second frame 118 may instruct manager code 114 to retrieve additional code 112. Second frame 118 may report to manager code 114 that the retrieval of additional code 112 was unsuccessful and may provide information to manager code 114 associated with the failed attempt at retrieving the requested code. The ability to inform manager code 114 of the status of retrieving additional code 112 may be advantageous, in certain embodiments, because manager code 114 may be able to inform a user of client 104 of errors while loading a page. Further, in various embodiments, this may be advantageous because manager code 114 may be able to take corrective actions such as renewing the attempt to retrieve the additional code. While an example operation has been generally discussed here, further example operations and/or details are discussed below with respect to FIGS. 2-4.

FIG. 2 is a flowchart depicting an example operation of manager code 114 discussed with respect to FIG. 1. In general, the steps illustrated may be combined, modified, or deleted where appropriate, and additional steps may also be added to the example operation. Furthermore, the described steps may be performed in any suitable order.

At step 202, the manager code may receive a request to acquire additional code, such as in the examples described above with respect to FIG. 1. At step 204, the manager code may determine if the URL indicating the location of the code is valid. If the URL is not valid, the manager code may respond to the request to acquire additional code with an error message, as in step 206. The error message may include information used or acquired by the manager code during the determination in step 204. If the URL is valid, the manager code may proceed to step 208. In various embodiments which implement these steps, an advantage may be realized in that errors may be detected early as opposed to directly attempting to download the additional code utilizing a mechanism such as a “script” tag.

At step 208, the manager code may direct the client to create a first frame, such as first frame 116. The source for the first frame may be stored in a server, such as edge server 106. The manager code may also provide the first frame with information regarding the retrieval of the additional code, such as the URL of the code. In some embodiments, the manager code may provide this information using a hash. In various embodiments, the manager code may utilize a query string to provide this information. At step 210, the manager code may monitor the first frame for errors, such as a timeout error. If the manager code detects errors from the first frame, it may proceed to step 206 and reply to the request for additional code with an error message. This reply may be accompanied by information regarding the error detected by the manager code at step 210. If the manager code does not detect an error with the first frame, it may proceed to step 212.

At step 212, the manager code may receive a message from a second frame. This second frame may be an inline frame created at the direction of the first frame. At step 214, the manager code determines if the code has been successfully retrieved based on the message received from the second frame in step 212. If the code was not successfully retrieved, the manger code may reply to the request for the additional code with an error message, as in step 206. This reply may include information surrounding the failure of retrieving the code. Such information may be delivered to the manager code in the message sent by the second frame in step 212. If the additional code has been successfully retrieved, the manger code may load the additional code, as in step 216.

At step 216, the manager code may load the requested additional code in multiple manners. For example, the manager code may use a “script” tag to load the additional code, passing in the URL the manager code received when the request for the additional code was initially presented. In some embodiments, the manager code may receive the additional code by utilizing a property of the second frame. For example, the second frame may have a name property which is set to be equivalent to the additional code. The manager code may then retrieve the additional code merely by reading the name property of the second frame.

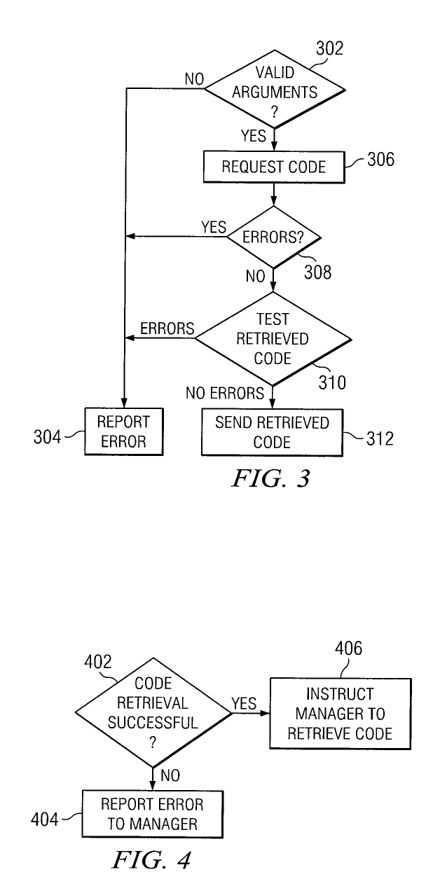

FIG. 3 is a flowchart depicting an example operation of the first frame discussed with respect to FIG. 1. In general, the illustrated steps may be combined, modified, or deleted where appropriate, and additional steps may also be added to the example operation. Furthermore, the described steps may be performed in any suitable order.

At step 302, the first frame receives arguments from the manager code. The validity of these arguments may be determined by the first frame. For example, the first frame may determine if the URL of the requested additional code is valid or properly formed. If the arguments are determined not to be valid, the first frame may report an error to the manager code, as in step 304. This report may include information such as which arguments were invalid, as determined in step 302.

At step 304, the first frame may report the existence of any errors occurring while retrieving the requested additional code as well as, in some embodiments, details regarding the error(s). In some embodiments, the first frame may communicate with the manager code by directing that a second frame be created. The information to be communicated to the manager code may be supplied to the second frame. In some embodiments, this information may be supplied in a hash. In particular embodiments, this information may be supplied using a query string. The second frame and its communication with the manager code is further discussed below with respect to FIG. 4.

At step 306, the first frame may attempt to acquire the requested additional code if the first frame has determined that the arguments passed to it from the manager code are valid. In some embodiments, the first frame may perform an XMLHttpRequest (XHR) to retrieve the requested additional code. The first frame may use other methods to retrieve the additional code, such as a “script” tag. At step 308, the first frame may monitor the progress of retrieving the additional code. If any errors occur during the retrieval of the additional code, the first frame may indicate this to the manager code at step 304. In particular embodiments, information regarding the error may be communicated to the manager code as well.

At step 310, in various embodiments, the first frame may test the retrieved code if no errors were determined in step 308. The first frame may, in some embodiments, perform more than one test. For example, items such as syntax, checksums, type-checking, and language may be analyzed through the test(s) performed by the first frame on the retrieved code. If any errors are discovered through the testing, the first frame may communicate the error(s) to the manager code at step 304. In some embodiments, the first frame may include information regarding the error(s) in the communication with the manager code.

At step 312, the first frame may direct that the retrieved code be communicated to the manager code. In some embodiments, the first frame causes a second frame to be created which may facilitate the receipt of the retrieved code by the manager code, as further described below with respect to FIG. 4.

FIG. 4 is a flowchart depicting an example operation of the second frame discussed with respect to FIG. 1. In general, the illustrated steps may be combined, modified, or deleted where appropriate, and additional steps may also be added to the example operation. Furthermore, the described steps may be performed in any suitable order.

At step 402, the second frame may receive information regarding the retrieval of the requested additional code. In some situations, the received information may direct the second frame to communicate the existence of error(s) during the attempted retrieval of the additional code to the manager code, as in step 404. The received information may also include, in some embodiments, details regarding any error(s) that occurred. In various embodiments, the second frame utilizes function calls to communicate with the manager code.

At step 406, the second frame may instruct the manager code to retrieve the requested additional code as indicated in the information received at step 402. In some example operations, the manager code may be instructed to retrieve the additional code by utilizing a “script” tag. This approach may provide an advantage in certain embodiments in that it does not require the additional code to be downloaded twice. This may be because the client may have the code stored in its cache because the first frame may have already retrieved the code as described above. In other example operations, the manager code may be instructed to retrieve the additional code by reading a field (or fields) of the second frame. The manager code may be instructed to read the “Name” field of the second frame, which may contain the additional code. One or more fields of the second frame may be set to all or part of the additional code. These fields may be so configured by the first frame. In various embodiments, this may be advantageous because it does not require that the additional code be downloaded more than once, which may improve performance.

Particular embodiments of a system and method of safe code loading have been described. Various advantages may be realized in the described embodiments. For example, additional code may be loaded as needed as opposed to downloading all of the code which may be utilized by the page when the page is first visited. This may lead to a better experience for the user. Further, additional code may be loaded utilizing edge servers which may increase performance. Additional code may also be tested and verified before being executed.

Although several embodiments have been illustrated and described in detail, it will be recognized that modifications and substitutions are possible without departing from the spirit and scope of the appended claims.

What is claimed is:

1. A method for retrieving code, comprising:
transmitting, from a first origin, manager code to a client, wherein the manager code is, when executed, operable to:
receive a request for retrieval of a target code hosted by a second origin;
create a first frame in a structured document;
send information regarding the target code to the first frame;
receive a status regarding retrieval of the target code;
communicating the status regarding retrieval of the target code; and
retrieving the target code; and
transmitting, from the first origin, a second frame comprising retrieval code, wherein the retrieval code is, when executed, operable to:
transmit the status regarding retrieval of the target code to the manager code; and
instruct the manager code to retrieve the target code.

2. The method of claim 1, wherein the first frame comprises an inline frame.

3. The method of claim 1, wherein the second origin comprises an edge server.

4. The method of claim 1, wherein the first frame is served from a second origin.

5. The method of claim 1, wherein transmitting the second frame from the first origin occurs in response to a request by the first frame.

6. The method of claim 1, wherein instructing the manager code to retrieve the target code further comprises instructing the manager code to read at least one attribute of the second frame.

7. The method of claim 1, wherein receiving a status regarding retrieval of the target code comprises receiving at least one test result performed by the first frame on the target code.

8. The method of claim 1, wherein the target code comprises Javascript.

9. The method of claim 1, wherein the first frame and the second frame comprise substantially the same code.

10. An apparatus comprising a processor and logic stored on a tangible computer-readable medium, wherein the logic, when executed is operable to:
transmit, from a first origin, manager code to a client, wherein the manager code is, when executed, operable to:
receive a request for retrieval of a target code hosted by a second origin;
create a first frame in a structured document;
send information regarding the target code to the first frame;
receive a status regarding retrieval of the target code;
communicating the status regarding retrieval of the target code; and
retrieving the target code; and
transmit, from the first origin, a second frame comprising retrieval code, wherein the retrieval code is, when executed, operable to:
transmit the status regarding retrieval of the target code to the manager code; and
instruct the manager code to retrieve the target code.

11. The apparatus of claim 10, wherein the first frame comprises an inline frame.

12. The apparatus of claim 10, wherein the second origin comprises an edge server.

13. The apparatus of claim 10, wherein the first frame is served from a second origin.

14. The apparatus of claim 10, wherein transmitting the second frame from the first origin occurs in response to a request by the first frame.

15. The apparatus of claim 10, wherein instructing the manager code to retrieve the target code further comprises instructing the manager code to read at least one attribute of the second frame.

16. The apparatus of claim 10, wherein receiving a status regarding retrieval of the target code comprises receiving at least one test result performed by the first frame on the target code.

17. The apparatus of claim 10, wherein the target code comprises Javascript.

18. The apparatus of claim 10, wherein the first frame and the second frame comprise substantially the same code.

19. A method for retrieving code, comprising:
receiving, from a process executing within the context of a structured document corresponding to a first origin, a request for retrieval of a target code hosted by a second origin;
creating a first frame in the structured document comprising a first retrieval code originating at a second origin, wherein the first retrieval code, when executed, is operable to:
receive information regarding the target code;
initiate a transfer of the target code from the second origin;
transmit a status regarding the retrieval of the target code; and
perform at least one test upon the target code;
creating a second frame comprising a second retrieval code originating at the first origin, wherein the second retrieval code, when executed, is operable to:
receive information regarding the target code;
transmit a status regarding the retrieval of the target code; and
instruct the manager code to retrieve the target code.

20. The method of claim 19, wherein instructing the manager code to retrieve the target code further comprises instructing the manager code to read at least one attribute of the second frame.
